(19) United States
(12) Patent Application Publication
(10) Pub. No.: US 2022/0355945 A1
(43) Pub. Date: Nov. 10, 2022

(54) ASSEMBLY OF A PRIMARY STRUCTURE OF AN AIRCRAFT PYLON AND A REAR ENGINE ATTACHMENT COMPRISING AT LEAST ONE LATERAL FASTENING ELEMENT AND AIRCRAFT COMPRISING AT LEAST ONE SUCH ASSEMBLY

(71) Applicant: Airbus Operations (S.A.S.), Toulouse (FR)

(72) Inventors: Paolo Messina, Toulouse (FR); Olivier Pautis, Toulouse (FR)

(21) Appl. No.: 17/733,065

(22) Filed: Apr. 29, 2022

(30) Foreign Application Priority Data
May 4, 2021 (FR) 2104681

(51) Int. Cl. B64D 27/26

(52) U.S. Cl. CPC B64D 27/26; B64D 2027/266; B64D 2027/264

(57) ABSTRACT

An assembly includes a rear engine attachment having a joining part, and also at least one support connected to the joining part by a connecting system. A lower spar of a primary structure of an aircraft pylon has a central part and also first and second lips disposed on either side of the central part and oriented in the direction of the rear engine attachment. The support has a base connected to the central part of the lower spar, at least one transverse flange supporting the connecting system and also at least one longitudinal flange connected to the base, pressed against the first or second lip of the lower spar and connected to the latter by at least one lateral connecting element.

### CROSS-REFERENCE TO RELATED APPLICATION

This application claims priority to French patent application number 2104681 filed on May 4, 2021, the entire disclosure of which is incorporated by reference herein.

### TECHNICAL FIELD

The subject matter herein relates to an assembly of a primary structure of an aircraft pylon and an aircraft rear engine attachment comprising at least one lateral fastening element and also to an aircraft comprising at least one such assembly.

### BACKGROUND

According to a configuration visible in FIGS. 1 and 2, an aircraft 10 comprises a plurality of engine assemblies 12 that are positioned beneath the wing 14 of the aircraft 10.

An engine assembly 12 comprises an engine 16, a nacelle (not shown in FIG. 2) positioned around the engine 16 and also a pylon 18 that provides the connection between the engine 16 and the rest of the aircraft 10, in particular the wing 14.

For the remainder of the description, a longitudinal direction X is parallel to the axis of the engine A16. A transverse plane is a plane perpendicular to the longitudinal direction X. A transverse and horizontal direction Y is a direction perpendicular to the longitudinal direction X and horizontal. A transverse and vertical direction Z is a direction perpendicular to the longitudinal direction X and vertical. A vertical median plane is a plane parallel to the direction X and containing the engine axis A16. The terms front and rear refer to the direction of flow of the stream of air in the engine 16, this stream flowing from the front towards the rear.

The pylon 18 comprises a primary structure 20 in the form of a box that is connected to the engine 16 by a front engine attachment 22, a rear engine attachment 24 and a pair of thrust rods 26 that react the thrust forces.

According to an embodiment visible in FIGS. 3 and 4, the rear engine attachment 24 comprises a joining part 28, which is approximately triangular, one of the vertices of the joining part 28, oriented towards the pylon 18, being connected by a first connecting system 30 to a clevis 32 secured to the pylon 18, one of the sides of the joining part 28, oriented towards the engine 16, being connected to the engine 16 by second and third connecting systems 34, 36.

The clevis 32 has a base 38 pressed against the pylon 18 and two flanges 40, 40′ that are mutually parallel and connected to the base 38. In operation, the first connecting system 30 passes through the two flanges 40, 40′ and the joining part 28 positioned between the two flanges 40, 40′.

The clevis 32 is fastened to the pylon 18 by virtue of six fastening elements 42, which are disposed symmetrically with respect to the vertical median plane. These fastening elements 42 are removable and each comprise at least one cylindrical rod, all the cylindrical rods of the fastening elements 42 being mutually parallel and oriented parallel to the direction Z.

The primary structure 20 of the pylon 18 comprises upper and lower spars 44 and also lateral walls 46.

According to a first embodiment, visible in FIG. 4, the upper and lower spars 44 are substantially flat and each lateral wall 46 has a C shape and comprises lips 46.1 pressed against the internal faces of the upper and lower spars 44. According to this first embodiment, the fastening elements 42 pass through the lower spar 44, the lips 46.1 of the lateral walls 46 and also the base 38 of the clevis 32. In a transverse plane, the fastening elements 42 are separated by a distance d1.

According to a second embodiment, visible in FIG. 5, the lateral walls 46 are substantially flat and each upper and lower spar 44 has a U shape and comprises lips 44.1 pressed against the internal faces of the lateral walls 46. According to this second embodiment, the fastening elements pass through the lower spar 44 and the base 38 of the clevis 32. This second embodiment makes it possible to reduce the transverse dimension of the pylon and improves the aerodynamic characteristics of the pylon 18. However, the reduction in the distance d2 between the fastening elements 42 in the transverse planes leads to an increase in the diameter of the cylindrical rods of the fastening elements 42 and therefore the on-board mass.

The disclosure herein aims to remedy all or some of the drawbacks of the prior art.

### SUMMARY

To this end, the disclosure herein relates to an assembly comprising a lower spar of a primary structure of an aircraft pylon and also a rear engine attachment configured to connect the lower spar and an engine,
a. the lower spar having a U-shaped transverse section and comprising a central part and also first and second lips disposed on either side of the central part,
b. the rear engine attachment comprising a joining part, at least one support and also a connecting system connecting the joining part and the support,
c. the support having a base configured to be connected to the central part of the lower spar and also at least one transverse flange connected to the base and supporting the connecting system,
d. the assembly comprising at least one main fastening element connecting the base of the support and the central part of the lower spar.

According to the disclosure herein, the first and second lips of the lower spar are oriented in the direction of the rear engine attachment; the support comprises at least one longitudinal flange connected to the base and configured to be pressed against the first or second lip of the lower spar and the assembly comprises at least one first or second lateral connecting element connecting the longitudinal flange and the first or second lip of the lower spar.

This solution makes it possible to reduce the spacing of the main fastening elements in a transverse plane, and this tends to improve the aerodynamic characteristics of the pylon without however needing to increase the section of the fastening elements, and therefore the on-board mass, given the reaction of the transverse forces by the lateral fastening element.

According to another feature, at least one of the transverse flanges forms an angle bar with at least one of the longitudinal flanges.

According to another feature, for each support, the longitudinal flange and the base form an angle substantially identical to that formed between the central part and the first or second lip of the lower spar.

According to another feature, a first support having a first longitudinal flange connected to the first lip of the lower spar is distinct and separate from a second support having a second longitudinal flange connected to the second lip of the lower spar.

According to a first embodiment, the rear engine attachment comprises:
a. a first support that has:
   i. a first base connected to the central part of the lower spar,
   ii. first front and rear transverse flanges that are mutually parallel and configured to support the connecting system,
   iii. a first longitudinal flange connected to the first base and to the first front and rear transverse flanges, pressed against the first lip of the lower spar and connected to the latter by at least one first lateral fastening element,
b. a second support that has:
   i. a second base connected to the central part of the lower spar,
   ii. second front and rear transverse flanges that are mutually parallel and configured to support the connecting system,
   iii. a second longitudinal flange connected to the second base and to the second front and rear transverse flanges, pressed against the second lip of the lower spar and connected to the latter by at least one second lateral fastening element.

According to another feature, the second base of the second support is directly pressed against the central part of the lower spar, the first base of the first support being pressed against the second base, each main fastening element passing through the first and second bases.

According to another feature, the first front and rear transverse flanges are positioned between the second front and rear transverse flanges and pressed against the latter.

According to a second embodiment, the rear engine attachment comprises:
a. a first front support that has:
   i. a first front base connected to the central part of the lower spar,
   ii. a first front transverse flange configured to support the connecting system,
   iii. a first front longitudinal flange connected to the first front base and to the first front transverse flange, pressed against the first lip of the lower spar and connected to the latter by at least one first lateral fastening element,
b. a first rear support that has:
   i. a first rear base connected to the central part of the lower spar,
   ii. a first rear transverse flange configured to support the connecting system,
   iii. a first rear longitudinal flange connected to the first rear base and to the first rear transverse flange, pressed against the first lip of the lower spar and connected to the latter by at least one first lateral fastening element,
c. a second front support that has:
   i. a second front base connected to the central part of the lower spar,
   ii. a second front transverse flange configured to support the connecting system,
   iii. a second front longitudinal flange connected to the second front base and to the second front transverse flange, pressed against the second lip of the lower spar and connected to the latter by at least one second lateral fastening element,
d. a second rear support that has:
   i. a second rear base connected to the central part of the lower spar,
   ii. a second rear transverse flange configured to support the connecting system,
   iii. a second rear longitudinal flange connected to the second rear base and to the second rear transverse flange, pressed against the second lip of the lower spar and connected to the latter by at least one second lateral fastening element,
e. the first and second front and rear supports being connected to the central part of the lower spar such that the first and second front transverse flanges are pressed against one another and such that the first and second rear transverse flanges are pressed against one another.

The disclosure herein also relates to an aircraft comprising at least one assembly according to one of the preceding features.

### BRIEF DESCRIPTION OF THE DRAWINGS

Other features and advantages will become apparent from the following description of the disclosure herein, which description is given solely by way of example, with reference to the appended drawings in which:

FIG. 1 is a perspective view of an aircraft;

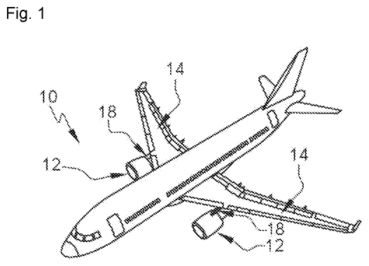

FIG. 2 is a side view of an engine assembly without nacelle that illustrates a connection between an engine and an aircraft pylon;

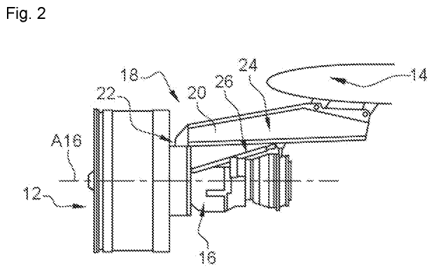

FIG. 3 is a perspective view of a part of a rear engine attachment that illustrates an embodiment according to the prior art;

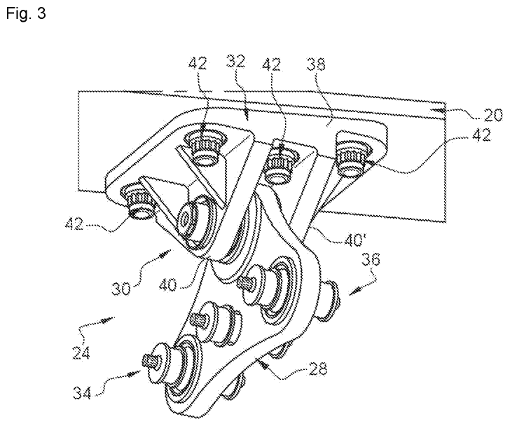

FIG. 4 is a schematic cross section of a part of a primary structure of an aircraft pylon and of a rear engine attachment illustrating a first embodiment of the prior art;

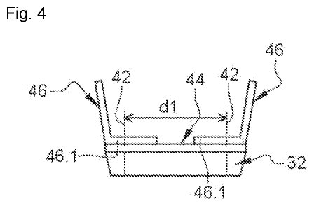

FIG. 5 is a schematic cross section of a part of a primary structure of an aircraft pylon and of a rear engine attachment illustrating a second embodiment of the prior art;

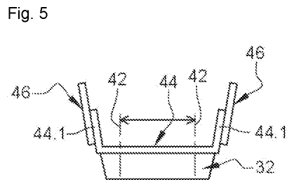

FIG. 6 is a schematic cross section of a part of a primary structure of an aircraft pylon and of a rear engine attachment illustrating an embodiment of the disclosure herein;

FIG. 7 is a perspective view from a first viewpoint of a part of a primary structure of an aircraft pylon and of a rear engine attachment illustrating a first embodiment of the disclosure herein;

FIG. 8 is a perspective view from a second viewpoint of the part of the primary structure and of the rear engine attachment that are visible in FIG. 7;

FIG. 9 is a view from below of the part of the primary structure and of the rear engine attachment that are visible in FIG. 7;

FIG. 10 is a perspective view of a part of a primary structure of an aircraft pylon and of a rear engine attachment illustrating a second embodiment of the disclosure herein; and

FIG. 11 is a view from below of the part of the primary structure and of the rear engine attachment that are visible in FIG. 10.

### DETAILED DESCRIPTION

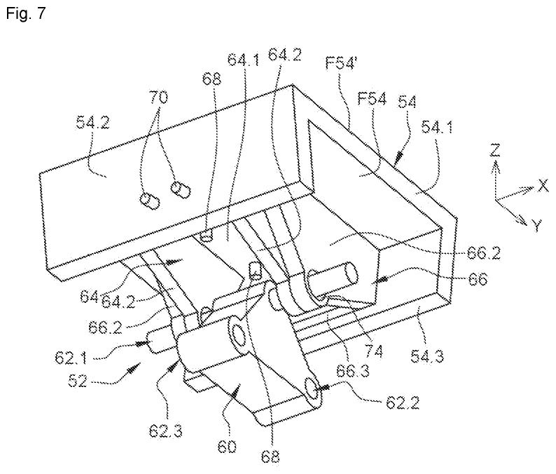

According to an embodiment visible in FIG. 7, an assembly comprises a primary structure 50 of a pylon of an aircraft and a rear engine attachment 52 connecting an engine (not shown) to the primary structure 50.

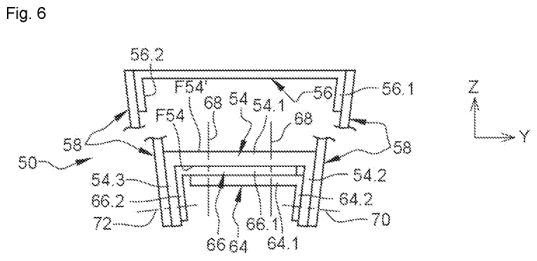

As illustrated in FIG. 6, the primary structure 50 comprises a lower spar 54, an upper spar 56 and also lateral walls 58.

The lower spar 54 comprises a central part 54.1 that has an external face F54 oriented towards the rear engine attachment 52 and an internal face F54′ oriented towards the upper spar 56 and opposite the external face F54 and also first and second lips 54.2, 54.3 disposed on either side of the central part 54.1, projecting with respect to the external face F54, which are oriented in the direction of the rear engine attachment 52. Thus, the lower spar 54 has a U-shaped transverse section of which the legs are oriented towards the rear engine attachment 52.

The first and second lips 54.2, 54.3 form the same angle with the central part 54.1, which is less than 90°, of the order of 80°. The first and second lips 54.2, 54.3 have the same height H (dimension considered in the direction Z between the central part 54.1 and the free edge of the first and second lips). The central part 54.1 has a width L corresponding to the dimension considered parallel to the direction Y between the first and second lips 54.2, 54.3.

According to one configuration, the lower spar 54 has a transverse section that is symmetric with respect to the vertical median plane.

Each lateral wall 58 is pressed against one of the first and second lips 54.2, 54.3 of the lower spar 54 and connected to the latter by fastening elements, such as rivets or bolts for example. Each lateral wall 58 covers the entire first or second lip 54.2, 54.3 to which it is connected. Of course, the disclosure herein is not limited to this embodiment in order to connect the lateral walls 58 and the first and second lips 54.2, 54.3 of the lower spar 54.

According to one configuration, the upper spar 56 also has a U shape and comprises lips 56.1, 56.2 to which the lateral walls 58 are connected. The disclosure herein is in no way limited to this configuration for the connection between the lateral walls 58 and the upper spar 56.

The rear engine attachment 52 comprises a joining part 60, which is approximately triangular, one of the vertices of the joining part 60, oriented towards the primary structure 50, being connected by a first connecting system 62.1 to at least one support 64, 66 fastened to the primary structure 50. According to one configuration, the joining part 60 comprises two plates pressed against one another and has a side connected to the engine by second and third connecting systems 62.2, 62.3. The joining part 60 and also the first, second and third connecting systems 62.1, 62.2, 62.3 are not described further since they can be identical to those of the prior art.

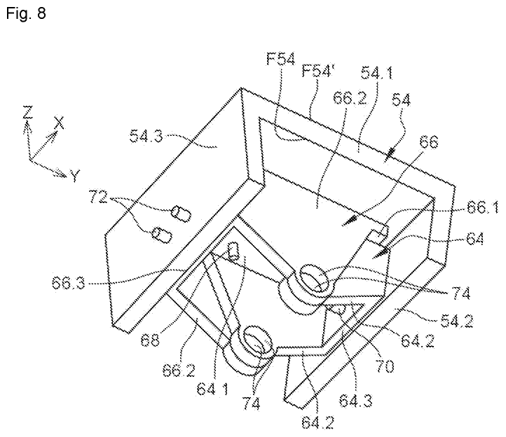

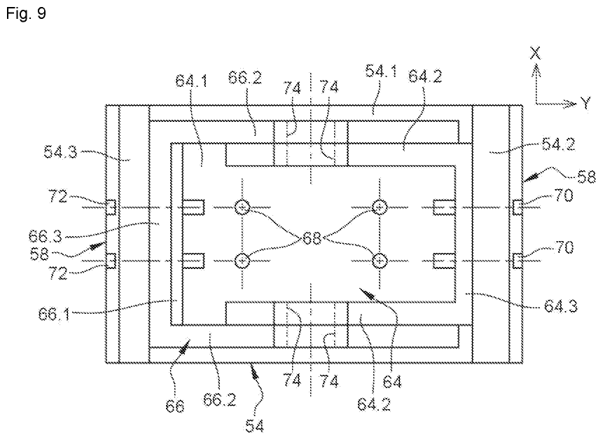

According to a first embodiment, visible in FIGS. 7 to 9, the rear engine attachment 52 comprises:
a. a first support 64 that has:
   i. a first base 64.1 configured to be connected to the central part 54.1 of the lower spar 54,
   ii. first front and rear transverse flanges 64.2 that are mutually parallel, perpendicular to the first base 64.1, positioned in transverse planes and configured to support the first connecting system 62.1,
   iii. a first longitudinal flange 64.3 connected to the first base 64.1 and to the first front and rear transverse flanges 64.2, configured to be pressed against the first lip 54.2 of the lower spar 54 and connected to the latter,
b. a second support 66 that has:
   i. a second base 66.1 configured to be connected to the central part 54.1 of the lower spar 54,
   ii. second front and rear transverse flanges 66.2 that are mutually parallel, perpendicular to the second base 66.1, positioned in transverse planes and configured to support the first connecting system 62.1,
   iii. a second longitudinal flange 66.3 connected to the second base 66.1 and to the second front and rear transverse flanges 66.2, configured to be pressed against the second lip 54.3 of the lower spar 54 and connected to the latter.

According to one embodiment, the first and second bases 64.1, 66.1, the first and second front and rear transverse flanges 64.2, 66.2 and also the first and second longitudinal flanges 64.3, 66.3 are each in the form of a plate.

According to a first configuration, the second base 66.1 of the second support 66 is directly pressed against the central part 54.1 of the lower spar 54 and the first base 64.1 of the first support 64 is pressed against the second base 66.1. In addition, the first front and rear transverse flanges 64.2 are positioned between the second front and rear transverse flanges 66.2 and pressed against the latter.

According to a second configuration, the first base 64.1 of the first support 64 is directly pressed against the central part 54.1 of the lower spar 54 and the second base 66.1 of the second support 66 is pressed against the first base 64.1. In addition, the second front and rear transverse flanges 66.2 are positioned between the first front and rear transverse flanges 64.2 and pressed against the latter.

For each of the first and second supports 64, 66, the first or second longitudinal flange 64.3, 66.3 and the first or second base 64.1, 66.1 form an angle substantially identical to that formed between the central part 54.1 and the first or second lip 54.2, 54.3 of the lower spar 54 such that for each of the first and second supports 64, 66, the first or second base 64.1, 66.1 is pressed against the central part 54.1 of the lower spar 54 and simultaneously the first or second longitudinal flange 64.3, 66.3 is pressed against the first or second lip 54.2, 54.3 of the lower spar 54.

The first and second longitudinal flanges 64.3, 66.3 have heights less than or equal to those of the first and second lips 54.2, 54.3. The first and second bases 64.1, 66.1 have widths (dimensions considered parallel to the direction Y) less than or equal to the width of the central part 54.1 of the lower spar 54.

The assembly comprises at least one main fastening element 68 connecting the first and second bases 64.1, 66.1 and the central part 54.1 of the lower spar 54 and at least one first lateral fastening element 70 connecting the first longitudinal flange 64.3 of the first support 64 and the first lip 54.2 of the lower spar 54 and also at least one second lateral fastening element 72 connecting the second longitudinal flange 66.3 of the second support 66 and the second lip 54.3 of the lower spar 54.

Thus, each main fastening element 68 passes through the first and second bases 64.1, 66.1. Each first lateral fastening element 70 passes through the first longitudinal flange 64.3 of the first support 64 and the first lip 54.2 of the lower spar 54. Each second lateral fastening element 72 passes through the second longitudinal flange 66.3 of the second support 66 and the second lip 54.3 of the lower spar 54.

This solution makes it possible to optimize the reaction of the forces between the rear engine attachment 52 and the primary structure 50, the main fastening elements 68 essentially reacting the forces in the direction Z, the first and second lateral fastening elements 70, 72 essentially reacting the forces in the direction Y and a moment in the longitudinal direction X.

According to one configuration, the assembly comprises two pairs of main fastening elements 68 positioned in first and second transverse planes, a first lateral fastening element 70 positioned in each of the first and second transverse planes and also a second lateral fastening element 72 positioned in each of the first and second transverse planes.

According to one configuration, the main and lateral fastening elements 68, 70, 72 are positioned symmetrically with respect to the vertical median plane.

In order to support the first connecting system 62.1, each transverse flange 64.2, 66.2 comprises a bore 74, the bores 74 in the various transverse flanges 64.2, 66.2 having the same diameter. For each of the first and second supports 64, 66, the bores 74 in the transverse flanges 64.2, 66.2 are coaxial. The first and second supports 64, 66 are joined such that the bores 74 in the transverse flanges 64.2, 66.2 are coaxial.

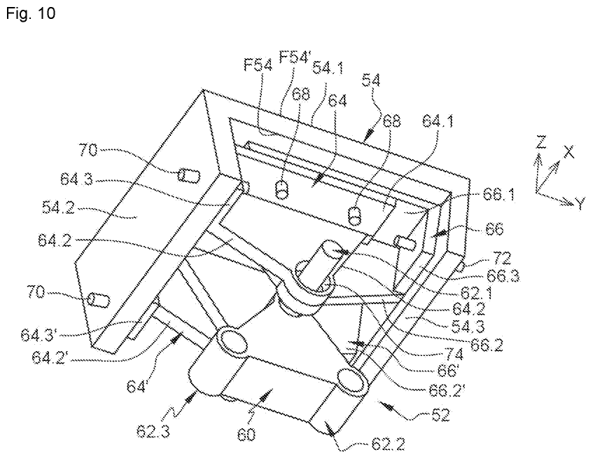

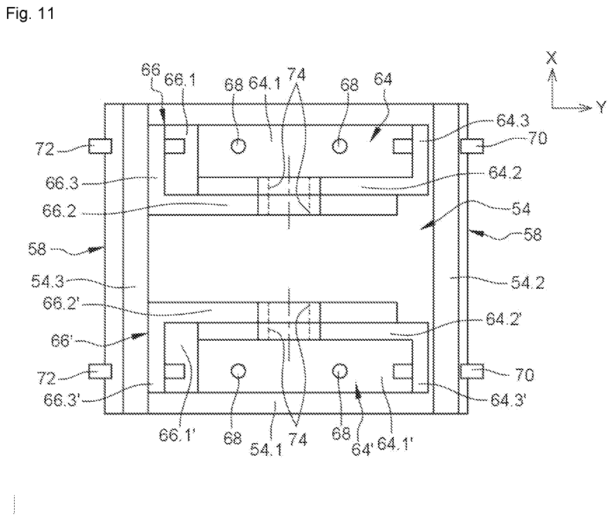

According to a second embodiment, visible in FIGS. 10 and 11, the rear engine attachment 52 comprises:
a. a first front support 64 that has:
   i. a first front base 64.1 configured to be connected to the central part 54.1 of the lower spar 54,
   ii. a first front transverse flange 64.2, perpendicular to the first front base 64.1, positioned in a transverse plane and configured to support the first connecting system 62.1,
   iii. a first front longitudinal flange 64.3 connected to the first front base 64.1 and to the first front transverse flange 64.2, configured to be pressed against the first lip 54.2 of the lower spar 54 and connected to the latter,
b. a first rear support 64′ that has:
   i. a first rear base 64.1′ configured to be connected to the central part 54.1 of the lower spar 54,
   ii. a first rear transverse flange 64.2′ perpendicular to the first rear base 64.1′, positioned in a transverse plane and configured to support the first connecting system 62.1,
   iii. a first rear longitudinal flange 64.3′ connected to the first rear base 64.1′ and to the first rear transverse flange 64.2′, configured to be pressed against the first lip 54.2 of the lower spar 54 and connected to the latter,
c. a second front support 66 that has:
   i. a second front base 66.1 configured to be connected to the central part 54.1 of the lower spar 54,
   ii. a second front transverse flange 66.2 perpendicular to the second front base 66.1 and configured to support the first connecting system 62.1,
   iii. a second front longitudinal flange 66.3 connected to the second front base 66.1 and to the second front transverse flange 66.2, configured to be pressed against the second lip 54.3 of the lower spar 54 and connected to the latter,
d. a second rear support 66′ that has:
   i. a second rear base 66.1′ configured to be connected to the central part 54.1 of the lower spar 54,
   ii. a second rear transverse flange 66.2′ perpendicular to the second rear base 66.1′ and configured to support the first connecting system 62.1,
   iii. a second rear longitudinal flange 66.3′ connected to the second rear base 66.1′ and to the second rear transverse flange 66.2′, configured to be pressed against the second lip 54.3 of the lower spar 54 and connected to the latter.

The first and second front and rear supports 64, 64′, 66, 66′ are connected to the central part 54.1 of the lower spar 54 such that:
a. the first and second front transverse flanges 64.2, 66.2 are pressed against one another and form a first arm of a clevis,
b. the first and second rear transverse flanges 64.2′, 66.2′ are pressed against one another and form a second arm of the clevis. According to this second embodiment, the joining part 60 is positioned between the first and second arms of the clevis thus formed.

According to a first configuration, the second front base 66.1 of the second front support 66 is pressed directly against the central part 54.1 of the lower spar 54 and the first front base 64.1 of the first front support 64 is pressed against the second front base 66.1. In parallel, the second rear base 66.1′ of the second rear support 66′ is pressed directly against the central part 54.1 of the lower spar 54 and the first rear base 64.1′ of the first rear support 64′ is pressed against the second rear base 66.1′.

According to a second configuration, the first front base 64.1 of the first front support 64 is pressed directly against the central part 54.1 of the lower spar 54 and the second front base 66.1 of the second front support 66 is pressed against the first front base 64.1. In parallel, the first rear base 64.1′ of the first rear support 64′ is pressed directly against the central part 54.1 of the lower spar 54 and the second rear base 66.1′ of the second rear support 66′ is pressed against the first rear base 64.1′.

In the case of the second embodiment, the assembly comprises:
a. at least one main fastening element 68 connecting the first and second front bases 64.1, 66.1 and the central part 54.1 of the lower spar 54,
b. at least one main fastening element 68 connecting the first and second rear bases 64.1′, 66.1′ and the central part 54.1 of the lower spar 54,
c. at least one first lateral fastening element 70 connecting the first front longitudinal flange 64.3 of the first front support 64 and the first lip 54.2 of the spar 54,
d. at least one first lateral fastening element 70 connecting the first rear longitudinal flange 64.3′ of the first rear support 64′ and the first lip 54.2 of the spar 54,
e. at least one second lateral fastening element 72 connecting the second front longitudinal flange 66.3 of the second front support 66 and the second lip 54.3 of the spar 54,
f. at least one second lateral fastening element 72 connecting the second rear longitudinal flange 66.3′ of the second rear support 66′ and the second lip 54.3 of the spar 54.

According to the second embodiment, the first and second front bases 64.1, 66.1 and also the first and second rear bases 64.1′, 66.1′ are positioned on either side of the first and second arms of the clevis that are formed by the first and second front and rear transverse flanges 64.2, 66.2, 64.2′ and 66.2′.

Each first or second front or rear transverse arm 64.2, 64.2′, 66.2, 66.2′ comprises a bore 74 in order to support the connecting system 62.1. These various bores have the same diameter and the various supports are joined such that the bores 74 are coaxial.

Of course, the disclosure herein is not limited to the first and second embodiments.

According to a simplified embodiment, the assembly comprises a support that comprises a base connected to the central part 54.1 of the lower spar 54 by at least one main fastening element 68, two front and rear transverse flanges supporting the connecting system 62.1, a first longitudinal flange connected to the base and to the two front and rear transverse flanges and fastened to the first lip 54.2 of the lower spar 54 by at least one first lateral fastening element 70 and also a second longitudinal flange connected to the base and to the two front and rear transverse flanges and fastened to the second lip 54.3 of the lower spar 54 by at least one second lateral fastening element 72.

Whatever the embodiment, the lower spar 54 comprises a central part 54.1 and also first and second lips 54.2, 54.3 disposed on either side of the central part 54.1 and positioned projecting with respect to the central part 54.1 in the direction of the rear engine attachment 52.

Orienting the first and second lips 54.2, 54.3 makes it possible to be able to use them for the transmission of the forces between the rear engine attachment and the primary structure, and this makes it possible to reduce the dimension in a transverse plane of the joining zone between the rear engine attachment and the primary structure.

The assembly comprises:
a. at least one support 64, 64′, 66, 66′ that has a base 64.1, 66.1, 64.1′, 66.1′ configured to be connected to the central part 54.1 of the lower spar 54, at least one transverse flange 64.2, 66.2, 64.2′, 66.2′, connected to the base 64.1, 66.1, 64.1′, 66.1′, supporting the connecting system 62.1 connecting the transverse flange 64.2, 66.2, 64.2′, 66.2′ and the joining part 60 and also at least one longitudinal flange 64.3, 66.3, 64.3′, 66.3′, connected to the base 64.1, 66.1, 64.1′, 66.1′ and configured to be connected to the first or second lip 54.2, 54.3 of the lower spar 54,
b. at least one main fastening element 68 connecting the base 64.1, 66.1, 64.1′, 66.1′ of the support 64, 64′, 66, 66′ and the central part 54.1 of the lower spar,
c. at least one lateral fastening element 70, 72 connecting the first or second longitudinal flange 64.3, 66.3, 64.3′, 66.3′ of the support 64, 64′, 66, 66′ and the first or second lip 54.2, 54.3 of the lower spar 54.

Providing at least one lateral fastening element 70, 72 connecting the first or second longitudinal flange 64.3, 66.3, 64.3′, 66.3′ of the support 64, 64′, 66, 66′ and the first or second lip 54.2, 54.3 of the lower spar 54 allows better transmission of the forces between the rear engine attachment 52 and the primary structure 50, in particular of the forces oriented in the direction Y. This configuration makes it possible to reduce the spacing of the main fastening elements 68 in a transverse plane, and this tends to improve the aerodynamic characteristics of the pylon without however needing to increase the section of the fastening elements and therefore the on-board mass given the reaction of the transverse forces by the lateral fastening elements 70, 72.

According to one embodiment, at least one of the transverse flanges 64.2, 66.2, 64.2′, 66.2′ forms an angle bar with at least one of the longitudinal flanges 64.3, 66.3, 64.3′, 66.3′. This configuration provides a direct force path between the transverse and longitudinal flanges.

According to another feature, a first longitudinal flange 64.3 connected to the first lip 54.2 of the lower spar 54 is incorporated in a first support 64 that is distinct and separate from a second support 66 comprising a second longitudinal flange 66.3 connected to the second lip 54.3 of the lower spar 54. Providing a plurality of supports simplifies the manufacturing process. Specifically, in the case of a single support, the latter has to be in contact with three distinct planes, and this leads to reduced dimensional and geometric tolerances and ultimately a complex and expensive manufacturing process.

Finally, providing a plurality of supports makes it possible to still keep force paths operational in the event of failure of one support.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An assembly comprising:
a lower spar of a primary structure of an aircraft pylon and a rear engine attachment configured to connect the lower spar and an engine;
the lower spar having a U-shaped transverse section and comprising a central part and also first and second lips disposed on either side of the central part;
the rear engine attachment comprising a joining part, at least one support and a connecting system connecting the joining part and the support;
the support having a base configured to be connected to the central part of the lower spar and also at least one transverse flange connected to the base and supporting the connecting system; and
at least one main fastening element connecting the base of the support and the central part of the lower spar;
wherein the first and second lips of the lower spar are oriented in a direction of the rear engine attachment, and the support comprises at least one longitudinal flange connected to the base and configured to be pressed against the first or second lip of the lower spar and the assembly comprises at least one first or second lateral connecting element connecting the longitudinal flange and the first or second lip of the lower spar.

2. The assembly according to claim 1, wherein at least one of the transverse flanges forms an angle bar with at least one of the longitudinal flanges.

3. The assembly according to claim 1, wherein, for each support, the longitudinal flange and the base form an angle substantially identical to that formed between the central part and the first or second lip of the lower spar.

4. The assembly according to claim 1, wherein a first support having a first longitudinal flange connected to the first lip of the lower spar is distinct and separate from a second support having a second longitudinal flange connected to the second lip of the lower spar.

5. The assembly according to claim 4, wherein the rear engine attachment comprises:
a first support comprising:
a first base connected to the central part of the lower spar;
first front and rear transverse flanges that are mutually parallel and configured to support the connecting system; and
a first longitudinal flange connected to the first base and to the first front and rear transverse flanges, pressed against the first lip of the lower spar and connected to the latter by at least one first lateral fastening element; and
a second support comprising:
a second base connected to the central part of the lower spar;
second front and rear transverse flanges that are mutually parallel and configured to support the connecting system; and
a second longitudinal flange connected to the second base and to the second front and rear transverse flanges, pressed against the second lip of the lower spar and connected to the latter by at least one second lateral fastening element.

6. The assembly according claim 5, wherein the second base of the second support is directly pressed against the central part of the lower spar, the first base of the first support being pressed against the second base, each main fastening element passing through the first and second bases.

7. The assembly according to claim 6, wherein the first front and rear transverse flanges are positioned between the second front and rear transverse flanges and pressed against the latter.

8. The assembly according to claim 4, wherein the rear engine attachment comprises:
a first front support comprising:
a first front base connected to the central part of the lower spar;
a first front transverse flange configured to support the connecting system; and
a first front longitudinal flange connected to the first front base and to the first front transverse flange, pressed against the first lip of the lower spar and connected to the latter by at least one first lateral fastening element;
a first rear support comprising:
a first rear base connected to the central part of the lower spar;
a first rear transverse flange configured to support the connecting system; and
a first rear longitudinal flange connected to the first rear base and to the first rear transverse flange, pressed against the first lip of the lower spar and connected to the latter by at least one first lateral fastening element; and
a second front support comprising:
a second front base connected to the central part of the lower spar;
a second front transverse flange configured to support the connecting system;
a second front longitudinal flange connected to the second front base and to the second front transverse flange, pressed against the second lip of the lower spar and connected to the latter by at least one second lateral fastening element; and
a second rear support comprising:
a second rear base connected to the central part of the lower spar;
a second rear transverse flange configured to support the connecting system; and
a second rear longitudinal flange connected to the second rear base and to the second rear transverse flange, pressed against the second lip of the lower spar and connected to the latter by at least one second lateral fastening element;
the first and second front and rear supports being connected to the central part of the lower spar such that the first and second front transverse flanges are pressed against one another and such that the first and second rear transverse flanges are pressed against one another.

9. An aircraft comprising at least one assembly according to claim 1.
